(19) United States
(12) Patent Application Publication
(10) Pub. No.: US 2022/0197227 A1
(43) Pub. Date: Jun. 23, 2022

(54) METHOD AND DEVICE FOR ACTIVATING A TECHNICAL UNIT

(71) Applicant: Robert Bosch GmbH, Stuttgart (DE)

(72) Inventors: Jan Guenter Woehlke, Leonberg (DE); Felix Schmitt, Ludwigsburg (DE)

(21) Appl. No.: 17/601,366

(22) PCT Filed: Mar. 24, 2020
(86) PCT No.: PCT/EP2020/058206

§ 371 Date: Oct. 4, 2021

(30) Foreign Application Priority Data
Apr. 12, 2019 (DE) 10 2019 205 359.9

(51) Int. Cl. G05B 13/02; G06K 9/62

(52) U.S. Cl. CPC G05B 13/027; G06K 9/6262; G05B 13/0205

(57) ABSTRACT

A computer-implemented method and device for activating a technical unit. The device includes an input for input data from at least one sensor, an output for activating the technical unit using an activation signal, and a computing device which activates the technical unit as a function of the input data. A state of at least one part of the technical unit or of surroundings is determined as a function of input data. At least one action is determined as a function of the state and of a strategy for the technical unit. Technical unit being activated to carry out the at least one action. The strategy, represented by an artificial neural network, is learned with a reinforcement learning algorithm in interaction with the technical unit or with the surroundings as a function of the at least one feedback signal. The feedback signal is determined as a function of a target-setting.

### BACKGROUND INFORMATION

Monte Carlo Tree search and reinforcement learning are approaches with which strategies for activating technical units are discoverable or learnable. Strategies once discovered or learned are then usable for activating technical units.

It is desirable to accelerate or at first enable the discovery or learning of a strategy.

### SUMMARY

This may achieved by the computer-implemented method and the device in accordance with example embodiments of the present invention.

In accordance with an example embodiment of the present invention, the computer-implemented method for activating a technical unit provides that the technical unit is a robot, an at least semi-autonomous vehicle, a house control system, a household appliance, a DIY tool, in particular, a power tool, a manufacturing machine, a personal assistance device, a monitoring system or an access control system, a state of at least one part of the technical unit or of surroundings of the technical unit being determined as a function of input data, at least one action being determined as a function of the state and of a strategy for the technical unit, and the technical unit being activated to carry out the at least one action, the strategy, represented in particular by an artificial neural network, being learned using a reinforcement learning algorithm in interaction with the technical unit or the surroundings of the technical unit as a function of the at least one feedback signal, the at least one feedback signal being determined as a function of a target-setting, at least one start state and/or at least one target state being determined for an interaction episode proportionally to a value of a continuous function, the value being determined by applying the continuous function to a performance measure previously determined for the strategy, by applying the continuous function to a derivative of a performance measure determined for the strategy, by applying the continuous function to an, in particular, temporal change of a performance measure determined for the strategy, by applying the continuous function to the strategy or by a combination of these applications. The target-setting includes, for example, achieving a target state g. An arbitrary reinforcement learning training algorithm trains a strategy πᵢ(a|s) or πᵢ(a|s,g) in interaction with surroundings over multiple iterations. The interaction with the surroundings takes place in interaction episodes, i.e., episodes or rollouts, which begin in a start state s₀ and end by achieving a target-setting or a maximal time horizon T. In the case of the target-based reinforcement learning, the target-setting includes achieving target states g, more generally but in addition to or instead of which, may also make specifications with respect to an obtained reward r. A distinction is made below between an actual target-setting of a problem and a temporary target-setting of an episode. The actual target-setting of the problem is, for example, to achieve a target from any possible start state or to achieve all possible targets from one start state. The temporary target-setting of an episode, for example, in target-based reinforcement learning, is the achievement of a particular target from the start state of the episode.

During a training, the start states/target states of the episodes may, in principle, be freely selected if the technical unit and the surroundings allow it, regardless of the target-setting of the actual problem. If a target state g or if multiple target states is/are permanently predefined, the start states s₀ are required for the episodes. If, on the other hand, start states s₀ are permanently predefined, then target states g are required in the case of target-based reinforcement learning. In principle, both may also be selected.

The selection of start states/target states during the training influences the training behavior of strategy π with respect to achieving the actual target-setting of the problem. In scenarios in which, in particular, the surroundings only sparingly grant rewards r, this means seldom r unequal to 0, the training is very difficult to impossible and a skillful selection of start states/target states during the training may immensely improve or even first enable the training progress with respect to the actual target-setting of the problem.

In the method in accordance with an example embodiment of the present invention, a curriculum of start states/target states is generated over the course of the training. This means that start states/target states for the episodes are selected according to a probability distribution, to a meta-strategy π^{s}^{₀} or π^{g}, which are recalculated from time to time over the course of training. This occurs by applying a continuous function G to an estimated, state-dependent performance measure Ĵ_{π}_{ᵢ}. This state-dependent performance measure Ĵ_{π}_{ᵢ} is estimated on the basis of data collected from the interaction of strategy π with the surroundings, i.e., states s, actions a, rewards r and/or additionally collected data. Performance measure Ĵ_{π}_{ᵢ}, for example, represents a target achievement probability, with which the achievement of the target-setting for each state is estimated as a possible start state or target state.

Start states/target states are selected, for example, in accordance with a probability distribution. For example, it is conventional to select start states according to a uniform distribution across all possible states. Using a probability distribution, which is determined by applying a continuous function to performance measure Ĵ_{π}_{ᵢ}, to a derivative of the performance measure, to an, in particular, temporal change of the performance measure, to strategy π or to a combination of these applications, improves the training progress significantly. The probability distribution generated by this application represents a meta-strategy for selecting start states/target states.

Particular explicit embodiments of the meta-strategy show empirically an improved training progress as compared to a conventional reinforcement learning algorithm with or without a curriculum of start states/target states. In contrast to existing curriculums approaches, fewer or no hyper-parameters, i.e., setting parameters, have to be determined for determining the curriculum. Moreover, the meta-strategies may be successfully applied to many different surroundings since, for example, no assumptions about the surroundings dynamic have to be made or, in the case of a permanently predefined target state, target state g does not have to be known from the outset. In addition, no demonstrations of a reference strategy are required in contrast to conventional demonstration-based algorithms.

The start states and/or target states are determined in accordance with a state distribution. These may be sampled, i.e., they are discoverable with the aid of meta-strategy π^{s}^{₀} or π^{g} as a function of continuous function G. Start states s₀ are sampled in the case of predefined target state g. Target states g are sampled in the case of predefined start state s₀. Both states may also be sampled. A performance measure J_{π}_{ᵢ}(s₀=s) is used for start states s₀. A performance measure J_{π}_{ᵢ}(g=s) is used for target states g. In addition or alternatively, a derivative of the respective performance measure is used, for example, gradient ∇ₛ_{₀}J_{π}_{ᵢ}(s₀=s); ∇_{g}J_{π}_{ᵢ}(g=s) or the, in particular, temporal change of respective performance measure ΔᵢJ_{π}_{ᵢ}(s₀=s); ΔᵢJ_{π}_{ᵢ}(g=s), or strategy πᵢ(a|s) or πᵢ(a|s,g). In an iteration i of the training of the strategy, the meta-strategy defines either start states s₀ or target states g of the interaction episodes with the surroundings or both. Meta-strategy π^{s}^{₀} for selecting start state s₀ is defined by performance measure J_{π}_{ᵢ}(s₀=s), a derivative of the performance measure, for example, gradient ∇ₛ_{₀}J_{π}_{ᵢ}(s₀=s), the in particular temporal change of performance measure ΔᵢJ_{π}_{ᵢ}(s₀=s) and/or strategy πᵢ(a|s). Meta-strategy π^{g} for the selection of target states g is defined by performance measure J_{π}_{ᵢ}(g=s), a derivative of the performance measure, for example, gradient ∇_{g}J_{π}_{ᵢ}(g=s), the in particular temporal change of performance measure ΔᵢJ_{π}_{ᵢ}(g=s) and/or strategy πᵢ(a|s,g). This approach is very generally applicable and may assume many different specific forms depending on the selection of the performance measure, the mathematical operations potentially applied thereto, i.e., derivative or in particular temporal change, and continuous function G for determining the state distribution. Fewer or no hyper-parameters have to be established, which may decide the success or failure of the approach. No demonstrations for detecting a reference strategy are required. Meaningful start states that accelerate or even first enable the training process in difficult surroundings are, among other things, for example, in the selection of start states, applied proportionally to a continuous function G to the derivative or to the gradient of the performance measure with respect to the state, selectable at precisely a limit at which the states having a higher target achievement probability or performance are next to those having a lower target achievement probability or performance. The derivative or the gradient in this case provides information about the change of the performance measure. A local improvement of the strategy is sufficient in order to increase the target achievement probability or performance of the states having previously low target achievement probability or performance. In contrast to an undirected spread of the start states, start states are prioritizable in a directed manner according to a criterion applied to a performance measure. The same applies to a spread of the target states when these are selected.

It is preferably provided that the performance measure is estimated. Estimated performance measure Ĵ_{π}_{ᵢ}(s₀=s) represents a good approximation for performance measure J_{π}_{ᵢ}(s₀=s). Estimated performance measure Ĵ_{π}_{ᵢ}(g=s) represents a good approximation for performance measure J_{π}_{ᵢ}(g=s).

It is preferably provided that the estimated performance measure is defined by a state-dependent target achievement probability, which is determined for possible states or for a subset of possible states, at least one action and at least one state to be expected or resulting from an execution of the at least one action by the technical unit being determined with the strategy starting with the start state, the target achievement probability being determined as a function of the target-setting, for example, of a target state, and as a function of at least one to be expected or resulting state. The target achievement probability is determined, for example, for all states of the state space or for a subset of these states by carrying out one or multiple episodes each of the interaction with the surroundings, i.e., rollouts using the strategy, starting from the selected states as start states or using a target-setting of the selected states as target states, at least one action and at least one state to be expected or resulting from an execution of the at least one action by the technical unit being determined using the strategy in each episode starting from the start state, the target achievement probability being determined as a function of the target-setting and as a function of at least one to be expected or resulting state. The target achievement probability indicates, for example, with what probability a target state g is achieved from start state s₀ within a certain number of interaction steps. The rollouts are somewhat a part of the reinforcement learning training or are additionally carried out.

In accordance with an example embodiment of the present invention, it is preferably provided that the estimated performance measure is defined by a value function or an advantage function, which is determined as a function of at least one state and/or at least one action and/or by the start state and/or the target state. The value function is, for example, value function V(s),Q(s,a),V(s,g),Q(s,a,g) or an advantage function A(s,a)=Q(s,a)−V(s) or A(s,a,g)=Q(s,a,g)−V(s,g) resulting therefrom, which is already determined by some reinforcement learning algorithms. A value function or advantage function may also be learned separately from the actual reinforcement learning algorithm, for example, with the aid of supervised learning from the states, rewards, actions and/or target states observed or carried out from the reinforcement learning training in the interaction with the surroundings.

It is preferably provided that the estimated performance measure is defined by a parametric model, the model being learned as a function of at least one state and/or of at least one action and/or of the start state and/or of the target state. The model may be learned from the reinforcement learning algorithm itself or separately from the actual reinforcement learning algorithm, for example, with the aid of supervised learning from the states, rewards, actions and/or target states observed or carried out based on the reinforcement learning training in the interaction with the surroundings.

It is preferably provided that the strategy is trained by interaction with the technical unit and/or the surroundings, at least one start state being determined as a function of a start state distribution and/or at least one target state being determined as a function of a target state distribution. This enables a particularly effective learning of the strategy.

It is preferably provided that a state distribution is defined as a function of the continuous function, the state distribution defining either a probability distribution across start states for a predefined target state, or a probability distribution across target states for a predefined start state. The state distribution represents a meta-strategy. As previously explained in the preceding sections, the learning behavior of the strategy in the case of sparse feedback of the surroundings is thereby improved or only enabled with the aid of reinforcement learning.

This results in a better strategy, which makes better action decisions and outputs these as an output variable.

In accordance with an example embodiment of the present invention, it is preferably provided that for a predefined target state, a state is determined as the start state of an interaction episode or for a predefined start state, a state is defined as the target state of an interaction episode, the state being defined, by a sampling method, in particular, in the case of a discrete, finite state space, as a function of the state distribution, a finite set of possible states, in particular, for a continuous or infinite state space being ascertained, in particular, with the aid of a rough grid approximation of the state space. For example, the state distribution is sampled with the aid of a standard sampling method. The start states and/or target states are sampled accordingly, for example, according to the state distribution with the aid of direct sampling, rejection sampling or Markov Chain Monte Carlo sampling. The training of a generator may be provided, which generates the start states and/or target states according to the state distribution. In a continuous state space or in a discrete state space including an infinite number of states, a finite set of states, for example, is sampled beforehand. For this purpose a rough grid approximation of the state space may be used.

It is preferably provided that the input data are defined by data from a sensor, in particular, from a video sensor, a radar sensor, a LIDAR sensor, an ultrasonic sensor, a motion sensor, a temperature sensor or a vibration sensor. With these sensors, in particular, the method is particularly efficiently applicable.

The device for activating the technical unit in accordance with an example embodiment of the present invention includes an input for input data from at least one sensor, an output for activating the technical unit and a computing device, which is designed to activate the technical unit as a function of the input data according to the method(s).

### BRIEF DESCRIPTION OF THE DRAWINGS

Further advantageous specific embodiments result from the following description and from the figures.

FIG. 1 schematically shows a representation of parts of a device for activating a technical unit, in accordance with an example embodiment of the present invention.

FIG. 2 shows a first flowchart for parts of a first method for activating the technical unit, in accordance with an example embodiment of the present invention.

FIG. 3 shows a second flowchart for parts of a second method for activating the technical unit, in accordance with an example embodiment of the present invention.

FIG. 4 shows a third flowchart for parts of the first method for activating the technical unit, in accordance with an example embodiment of the present invention.

FIG. 5 shows a fourth flowchart for parts of the second method for activating the technical unit, in accordance with an example embodiment of the present invention.

### DETAILED DESCRIPTION OF EXAMPLE EMBODIMENTS

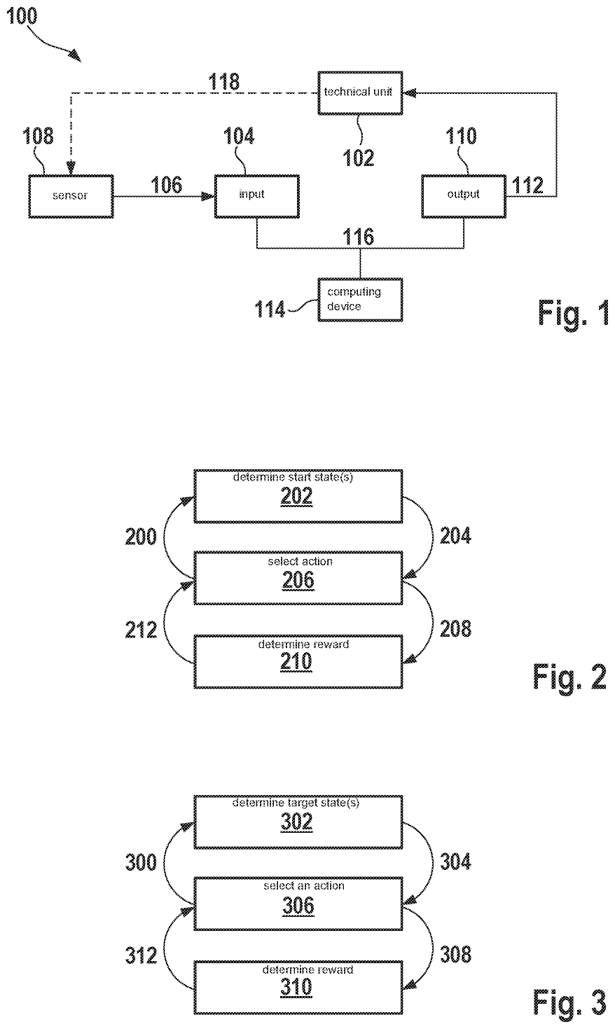

FIG. 1 shows a device 100 for activating a technical unit 102.

Technical unit 102 may be a robot, an at least semi-autonomous vehicle, a house control system, a household appliance, a DIY tool, in particular, a power tool, a manufacturing machine, a personal assistance device, a monitoring system or an access control system.

Device 100 includes an input 104 for input data 106 from a sensor 108 and an output 110 for activating technical unit 102 using at least one activation signal 112 and a computing device 114. A data connection 116, for example, a data bus, connects computing device 114 to input 104 and to output 110. Sensor 108 detects, for example, information 118 about a state of technical unit 102 or about the surroundings of technical unit 102.

Input data 106 in the example are defined by data from sensor 108. Sensor 108 is, for example, a video sensor, a radar sensor, a LIDAR sensor, an ultrasonic sensor, a motion sensor, a temperature sensor or a vibration sensor. Input data 106 are, for example, raw data from sensor 108 or previously prepared data. Multiple, in particular different, sensors may be provided, which provide different input data 106.

Computing device 114 is designed to determine a state s of technical unit 102 as a function of input data 106. Output 110 in the example is designed to activate technical unit 102 as a function of an action a, which is determined by computing device 114 as a function of a strategy π.

Device 100 is designed to activate technical unit 102 as a function of input data 106 according to a method described below as a function of strategy π.

In at least semi-autonomous or automated driving, the technical unit encompasses a vehicle. Input variables define, for example, a state s of the vehicle. The input variables are, for example, optionally pre-processed positions of other road users, roadway markings, traffic signs and/or other sensor data, for example, images, videos, radar data, LIDAR data, ultrasonic data. The input variables are, for example, data obtained from sensors of the vehicle or from other vehicles or from an infrastructure. An action a defines, for example, output variables for activating a vehicle. The output variables relate, for example, to action decisions, for example, lane change, increasing or reducing the speed of the vehicle. Strategy π in this example defines action a, which is to be carried out in a state s.

Strategy π may, for example, be implemented as a predefined set of rules or continuously regenerated in a dynamic manner using Monte Carlo Tree Search. Monte Carlo Tree Search is a heuristic search algorithm, which makes it possible to discover a strategy π for some decision-making processes. Since a fixed set of rules is not easily generalized and Monte Carlo Tree Search is very costly in terms of the required computing capacities, the use of reinforcement learning for learning strategy π from interaction with the surroundings is an alternative.

Reinforcement learning trains a strategy π(a|s), which is represented for example, by a neural network, and states s mapped as input variable onto actions a as an output variable. During the training, strategy π(a|s) interacts with surroundings and obtains a reward r. The surroundings may include wholly or in part the technical unit. The surroundings may include wholly or in part the surroundings of the technical unit. The surroundings may also include simulation surroundings, which simulate wholly or in part the technical unit and/or the surroundings of the technical unit.

Strategy π(a|s) is adapted on the basis of this reward r. Strategy π(a|s) is randomly initialized, for example, before the start of the training. The training is episodic. An episode, i.e., a rollout, defines the interaction of strategy π(a|s) with the surroundings or with the simulation surroundings over a maximum time horizon T. Starting from a start state s₀, the strategy repeatedly activates the technical unit with actions a, resulting in new states. The episode ends when a target-setting including, for example, a target state g or time horizon T, is achieved. During the episode, the following steps are carried out: determining action a using strategy π(a|s) in state s; carrying out action a in state s; determining a new state s′ resulting therefrom; repeating the steps, with new state s′ being used as state s. An episode is carried out, for example, in discrete interaction steps. The episodes end, for example, when the number of interaction steps reaches a limit corresponding to time horizon T or when the target-setting, for example, a target state g, has been achieved. The interaction steps may represent time steps. In this case, the episodes end when a time limit or the target-setting, for example, a target state g, is achieved.

For such an episode, start state s₀ must be determined. This may be selected from a state space S, for example, from a set of possible states of the technical unit and/or from its surroundings or simulation surroundings.

Start states s₀ for the various episodes may be established from state space S or uniformly sampled, i.e., randomly selected in a uniform manner.

These forms of the selection of start states s₀ may slow down or, in sufficiently difficult surroundings, completely prevent a learning of strategy π(a|s), in particular, in settings in which there are very few rewards r from the surroundings. This is due to the fact that strategy π(a|s) is randomly initialized before the start of the training.

Reward r is potentially only very sparingly granted in at least semi-autonomous or automated driving. A positive reward r is determined, for example, as feedback for reaching a target position, for example, of a freeway exit. A negative reward r is determined, for example, as feedback for the cause of a collision or the departure from a roadway. If, for example, reward r is determined in at least semi-autonomous or automated driving exclusively for a target achievement, i.e., achieving a desired target state g, fixed start states s₀ are very far removed from target state g or state space S is very large in uniform sampling of start states s₀ or obstacles in the surroundings also impede the progress, this means that only seldom or in the worst case are no rewards r obtained from the surroundings, since target state g is seldom even achieved before achieving the maximum number of interaction steps, or is achieved only after numerous interaction steps. This hinders the training progress when learning strategy π(a|s) or makes learning impossible.

In at least semi-autonomous or automated driving, in particular, it is very difficult to design reward r in such a way that desired driving behavior is promoted without causing undesirable side effects.

In this case, a curriculum of start states s₀ may be generated as one possible approach to a particular problem, which selects start states s₀ in such a way that rewards r are obtained often enough from the surroundings in order to ensure the training progress, strategy π(a|s) being defined in such a way that target state g is able to be achieved at some time from all start states s₀ provided by the problem. Strategy π(a|s) is defined, for example, in such a way that any arbitrary state is achievable in state space S.

An equivalent thereto is the problem of a target state selection in the case of predefined start state s₀. A target state g, which is very far removed from start state s₀ of a rollout, also means that there are only few rewards r from the surroundings and the learning process is hampered or becomes impossible as a result.

In this case, a curriculum of target states g may be generated as a possible approach to a particular problem, which selects target states g in the case of a predefined start state s₀ in such a way that rewards r are obtained often enough from the surroundings in order to ensure the training progress, strategy π(a|s) being defined in such a way that it is able at some point to achieve all target states g provided by the problem. Strategy π(a|s) is defined, for example, in such a way that, for example, any arbitrary state is achievable in state space S.

Such an approach for a curriculum for start states is described, for example, in Florensa et al., “Reverse Curriculum Generation for Reinforcement Learning,” https://arxiv.org/pdf/1707.05300.pdf.

Such an approach for a curriculum for target states is described, for example, in Held et al., “Automatic Goal Generation for Reinforcement Learning Agents,” https://arxiv.org/pdf/1705.06366.pdf.

For continuous and discrete state spaces S, a stochastic meta-strategy πᵢ^{s}^{₀}(s₀|J_{π}_{ᵢ}(s₀),∇ₛ_{₀}J_{π}_{ᵢ}(s₀),ΔᵢJ_{π}_{ᵢ}(s₀),πᵢ(a|s)) for selecting start states s₀ for the episodes of one or multiple successive training iterations of the algorithm for reinforcement learning may be defined on the basis of strategy π(a|s) of training iteration i.

Stochastic meta-strategy πᵢ^{s}^{₀} in this example is defined as a function of a performance measure J_{π}_{ᵢ}(s₀) of a derivative of the performance measure, for example, of gradient ∇ₛ_{₀}J_{π}_{ᵢ}(s₀), of a change of performance measure ΔᵢJ_{π}_{ᵢ}(s₀) and of actual strategy πᵢ(a|s). The change in the example is a temporal change.

If performance measure J_{π}_{ᵢ}(s₀), a derivative of the performance measure, for example, a gradient ∇ₛ_{₀}J_{π}_{ᵢ}(s₀), the change of performance ΔᵢJ_{π}_{ᵢ}(s₀) and/or strategy πᵢ(a|s) is predefined in an iteration i, meta-strategy πᵢ^{s}^{₀} defines a probability distribution across start states s₀. Start states s₀ are thus selectable as a function of meta-strategy πᵢ^{s}^{₀}.

For continuous and discrete state spaces S, a stochastic meta-strategy πᵢ^{g}(g|J_{π}_{ᵢ}(g),∇_{g}J_{π}_{ᵢ}(g),ΔᵢJ_{π}_{ᵢ}(g),πᵢ(a|s,g)) for selecting start states g for the episodes of one or multiple successive training iterations of the algorithm for reinforcement learning may be defined on the basis of strategy πᵢ(a|s,g) of training iteration i.

Stochastic meta-strategy πᵢ^{g} in this example is defined as a function of a performance measure J_{π}_{ᵢ}(g) of a derivative of the performance measure, for example, of gradient ∇_{g}J_{π}_{ᵢ}(g), of a change of performance measure ΔᵢJ_{π}_{ᵢ}(g) and of actual strategy πᵢ(a|s,g). The change in the example is a temporal change.

If performance measure J_{π}_{ᵢ}(g), a derivative of the performance measure, for example, of gradient ∇_{g}J_{π}_{ᵢ}(g), the change of performance ΔᵢJ_{π}_{ᵢ}(g) and/or strategy πᵢ(a|s,g) is predefined in an iteration i, meta-strategy πᵢ^{g} defines a probability distribution across target states g. Target states g are thus selectable as a function of meta-strategy πᵢ^{g}.

It may be provided to select either start state s₀ or target state g or both. A distinction is made below between two methods, one for selecting start state s₀ and one for selecting target state g. These may be carried out independently of one another or jointly in order to select only one of the states or both states jointly.

For determining start states s₀, meta-strategy πᵢ^{s}^{₀}(s₀|J_{π}_{ᵢ}(s₀),∇ₛ_{₀}J_{π}_{ᵢ}(s₀),ΔᵢJ_{π}_{ᵢ}(s₀),πᵢ(a|s)) is selected in such a way that states s are determined as start state s₀ from state space S or from a subset of these states proportionally to the value of a continuous function G. Function G is applied to performance measure J_{π}_{ᵢ}(s₀), to a derivative, for example, gradient ∇ₛ_{₀}J_{π}_{ᵢ}(s₀), to change ΔᵢJ_{π}_{ᵢ}(s₀), to strategy πᵢ(a|s) or to an arbitrary combination thereof, in order to determine start states s₀ of one or multiple episodes of the interaction with the surroundings. For this purpose,

p(s)∝G(J_{π}_{ᵢ}(s₀=s),∇ₛ_{₀}J_{π}_{ᵢ}(s₀=s),ΔᵢJ_{π}_{ᵢ}(s₀=s),πᵢ(a|s))

is determined, for example.

Start states s₀ for discrete, finite state spaces are sampled, for example as a function of performance measure J_{π}_{ᵢ}, proportionally to the value of continuous function G with

p(s)∝G(J_{π}_{ᵢ}(s₀=s))

Exemplary continuous functions G in the counter are indicated below, which satisfy this relationship, in particular, as a function of a denominator used for normalizing.

The following, for example, are sampled:

$$p ( s ) = \frac{{e}^{\frac{1}{η} {J}_{{π}_{i}} ( {s}_{0} = s )}}{{\sum }_{{s}^{′} ∈ S} {e}^{\frac{1}{η} {J}_{{π}_{i}} ( {s}_{0} = {s}^{′} )}} with η \to ∞ for i \to ∞ . \\ p ( s ) = \frac{- {J}_{{π}_{i}} ( {s}_{0} = s ) ln {J}_{{π}_{i}} ( {s}_{0} = s ) - ( 1 - {J}_{{π}_{i}} ( {s}_{0} = s ) ) ln ( 1 - {J}_{{π}_{i}} ( {s}_{0} = s ) )}{\begin{matrix}{\sum }_{{s}^{′} ∈ S} - {J}_{{π}_{i}} ( {s}_{0} = {s}^{′} ) ln {J}_{{π}_{i}} ( {s}_{0} = {s}^{′} ) - \\ ( 1 - {J}_{{π}_{i}} ( {s}_{0} = {s}^{′} ) ) ln ( 1 - {J}_{{π}_{i}} ( {s}_{0} = {s}^{′} ) )\end{matrix}} with η ∈ ℝ , \\ p ( s ) = \frac{{e}^{\frac{1}{η} ( - {J}_{{π}_{i}} ( {s}_{0} = s ) ln {J}_{{π}_{i}} ( {s}_{0} = s ) - ( 1 - {J}_{{π}_{i}} ( {s}_{0} = s ) ) ln ( 1 - {J}_{{π}_{i}} ( {s}_{0} = s ) ) )}}{{\sum }_{{s}^{′} ∈ S} {e}^{\frac{1}{η} ( - {J}_{{π}_{i}} ( {s}_{0} = {s}^{′} ) ln {J}_{{π}_{i}} ( {s}_{0} = {s}^{′} ) - ( 1 - {J}_{{π}_{i}} ( {s}_{0} = {s}^{′} ) ) ln ( 1 - {J}_{{π}_{i}} ( {s}_{0} = {s}^{′} ) ) )}} with η ∈ ℝ , \\ or$$

$$p ( s ) = \frac{\sqrt{{\sum }_{{s}_{N} ∈ {S}_{N ( s )}} {( {J}_{{π}_{i} ( {s}_{0} = {s}_{N} )} - {J}_{{π}_{i} ( {s}_{0} = s )} )}^{2}}}{{\sum }_{{s}^{′} ∈ S} \sqrt{{\sum }_{{s}_{N} ∈ {S}_{N ( {s}^{′} )}} {( {J}_{{π}_{i} ( {s}_{0} = {s}_{N} )} - {J}_{{π}_{i} ( {s}_{0} = {s}^{′} )} )}^{2}}} ,$$

S_{N(S)} being the set of all adjacent states of s, i.e., all states S_{N}, which are achievable in one time step from s by an arbitrary action a.

Start states s₀ may be sampled proportionally to the value of continuous function G applied to gradient ∇ₛ_{₀}J_{π}_{ᵢ} with

p(s)∝G(∇ₛ_{₀}J_{π}_{ᵢ}(s₀=s))

Exemplary continuous functions G in the counter are indicated below, which satisfy this relationship, in particular, as a function of a denominator used for normalizing.

$$p ( s ) = \frac{‖ {∇}_{{s}_{0}} {J}_{{π}_{i}} ( {s}_{0} = s ) {‖}_{2}}{{Σ}_{{s}^{′} ∈ S} {‖ {∇}_{{s}_{0}} {J}_{{π}_{i}} ( {s}_{0} = {s}^{′} ) ‖}_{2}} , \\ p ( s ) = \frac{{‖ {∇}_{{s}_{0}} {J}_{{π}_{i}} ( {s}_{0} = s ) ‖}_{2}^{2}}{{{Σ}_{{s}^{′} ∈ S} ‖ {∇}_{{s}_{0}} {J}_{{π}_{i}} ( {s}_{0} = {s}^{′} ) ‖}_{2}^{2}} , \\ p ( s ) = \frac{{e}^{\frac{1}{η} {‖ {∇}_{{s}_{0}} {J}_{{π}_{i}} ( {s}_{0} = s ) ‖}_{2}}}{{Σ}_{{s}^{′} ∈ s} {e}^{\frac{1}{η} {‖ {∇}_{{s}_{0}} {J}_{{π}_{i}} ( {s}_{0} = {s}^{′} ) ‖}_{2}}} , \\ or$$

$$p ( s ) = \frac{{e}^{\frac{1}{η} {‖ {∇}_{{s}_{0}} {J}_{{π}_{i}} ( {s}_{0} = s ) ‖}_{2}^{2}}}{{Σ}_{{s}^{′} ∈ s} {e}^{\frac{1}{η} {‖ {∇}_{{s}_{0}} {J}_{{π}_{i}} ( {s}_{0} = {s}^{′} ) ‖}_{2}^{2}}} .$$

Start states s₀ may be sampled proportionally to the value of continuous function G applied to change ΔᵢJ_{π}_{ᵢ} with

p(s)∝G(ΔᵢJ_{π}_{ᵢ}(s₀=s))

Exemplary continuous functions G in the counter are indicated below, which satisfy this relationship, in particular, as a function of a denominator used for normalizing. The following, for example, are sampled:

$$p ( s ) = \frac{‖ {Δ}_{i} {J}_{{π}_{i}} ( {s}_{0} = s ) {‖}_{2}}{{Σ}_{{s}^{′} ∈ S} {‖ {Δ}_{i} {J}_{{π}_{i}} ( {s}_{0} = {s}^{′} ) ‖}_{2}} , \\ p ( s ) = \frac{{‖ {Δ}_{i} {J}_{{π}_{i}} ( {s}_{0} = s ) ‖}_{2}^{2}}{{{Σ}_{{s}^{′} ∈ S} ‖ {Δ}_{i} {J}_{{π}_{i}} ( {s}_{0} = {s}^{′} ) ‖}_{2}^{2}} , \\ p ( s ) = \frac{{e}^{\frac{1}{η} {‖ {Δ}_{i} {J}_{{π}_{i}} ( {s}_{0} = s ) ‖}_{2}}}{{Σ}_{{s}^{′} ∈ s} {e}^{\frac{1}{η} {‖ {Δ}_{i} {J}_{{π}_{i}} ( {s}_{0} = {s}^{′} ) ‖}_{2}}} , \\ or$$

$$p ( s ) = \frac{{e}^{\frac{1}{η} {‖ {Δ}_{i} {J}_{{π}_{i}} ( {s}_{0} = s ) ‖}_{2}^{2}}}{{Σ}_{{s}^{′} ∈ s} {e}^{\frac{1}{η} {‖ {Δ}_{i} {J}_{{π}_{i}} ( {s}_{0} = {s}^{′} ) ‖}_{2}^{2}}} ,$$

where ΔᵢJ_{π}_{ᵢ}(s₀=s), for example, ΔᵢJ_{π}_{ᵢ}(s₀=s)=J_{π}_{ᵢ}(s₀=s)−J_{π}_{ᵢ₋ₖ}(s₀=s) with k∈ [symbol] ₊.

Start states s₀ may be sampled proportionally to the value of continuous function G applied to performance measure J_{π}_{ᵢ} and strategy πᵢ(a|s) with

p(s)∝G(J_{π}_{ᵢ}(s₀=s),πᵢ(a|s))

Exemplary continuous functions G in the counter are indicated below, which satisfy this relationship, in particular, as a function of a denominator used for normalizing. The following, for example, are sampled:

$$p ( s ) = \frac{𝕊 [ {J}_{{π}_{i}} ( {s}_{0} = s ) ]}{{Σ}_{{s}^{′} ∈ S} 𝕊 [ {J}_{{π}_{i}} ( {s}_{0} = {s}^{′} ) ]} ,$$

J_{πi} in this case being value function Q^{π}^{ᵢ}(s,a) with s=s₀ or advantage function A^{π}^{ᵢ}(s,a) with s=s₀ and [symbol] [.] being the standard deviation with respect to actions a, which is selected either from action space A or corresponding to strategy πᵢ(a|s),

$$p ( s ) = \frac{\sqrt{{\sum }_{a} {( {J}_{{π}_{i}} ( {s}_{0} = s ) )}^{2} {π}_{i} ( a \vert s )}}{{\sum }_{{s}^{′} ∈ S} \sqrt{{\sum }_{a} {( {J}_{{π}_{i}} ( {s}_{0} = {s}^{′} ) )}^{2} {π}_{i} ( a \vert {s}^{′} )}} ,$$

J_{π}_{ᵢ} in this case being advantage function A^{π}^{ᵢ}(s,a) (with s=s₀),
or

$$p ( s ) = \frac{{Σ}_{a} \vert {J}_{{π}_{i}} ( {s}_{0} = s ) \vert {π}_{i} ( a \vert s )}{{\sum }_{{s}^{′} ∈ S} {\sum }_{a} \vert {J}_{{π}_{i}} ( {s}_{0} = {s}^{′} ) ‖ {π}_{i} ( a \vert {s}^{′} )} ,$$

J_{π}_{ᵢ} in this case being the advantage function A^{π}^{ᵢ}(s,a) (with s=s₀).

To determine a target state g, meta-strategy πᵢ^{g}(g|J_{π}_{ᵢ}(g),∇_{g}J_{π}_{ᵢ}(g),ΔᵢJ_{π}_{ᵢ}(g),πᵢ(a|s,g)) is selected in such a way that states s are determined as target state g from state space S or from a subset of these states proportionally to the value of a continuous function G. Function G is applied to performance measure J_{π}_{ᵢ}(g), to a derivative, for example, gradient ∇_{g}J_{π}_{ᵢ}(g), to change ΔᵢJ_{π}_{ᵢ}(g), to strategy πᵢ(a|s,g) or to an arbitrary combination thereof, in order to determine target states g of one or multiple episodes of the interaction with the surroundings. For this purpose,

p(s)∝G(J_{π}_{ᵢ}(g=s),∇_{g}J_{π}_{ᵢ}(g=s),ΔᵢJ_{π}_{ᵢ}(g=s),πᵢ(a|s₀,g))

is determined.

Target states g for discrete, finite state spaces are sampled, for example as a function of performance measure J_{π}_{ᵢ}, proportionally to the value of continuous function G, with

p(s)∝G(J_{π}_{ᵢ}(g=s))

Exemplary continuous functions G in the counter are indicated below, which satisfy this relationship, in particular, as a function of a denominator used for normalizing. The following, for example, are sampled:

$$p ( s ) = \frac{{e}^{\frac{1}{η} {J}_{{π}_{i}} ( g = s )}}{{\sum }_{{s}^{′} ∈ S} {e}^{\frac{1}{η} {J}_{{π}_{i}} ( g = {s}^{′} )}} with η \to ∞ for i \to ∞ , \\ p ( s ) = \frac{- {J}_{{π}_{i}} ( g = s ) ln {J}_{{π}_{i}} ( g = s ) - ( 1 - {J}_{{π}_{i}} ( g = s ) ) ln ( 1 - {J}_{{π}_{i}} ( g = s ) )}{\begin{matrix}{\sum }_{{s}^{′} ∈ S} - {J}_{{π}_{i}} ( g = {s}^{′} ) ln {J}_{{π}_{i}} ( g = {s}^{′} ) - \\ ( 1 - {J}_{{π}_{i}} ( g = {s}^{′} ) ) ln ( 1 - {J}_{{π}_{i}} ( g = {s}^{′} ) )\end{matrix}} with η ∈ ℝ , \\ p ( s ) = \frac{{e}^{\frac{1}{η} ( - {J}_{{π}_{i}} ( g = s ) ln {J}_{{π}_{i}} ( g = s ) - ( 1 - {J}_{{π}_{i}} ( g = s ) ) ln ( 1 - {J}_{{π}_{i}} ( g = s ) ) )}}{{\sum }_{{s}^{′} ∈ S} {e}^{\frac{1}{η} ( - {J}_{{π}_{i}} ( g = {s}^{′} ) ln {J}_{{π}_{i}} ( g = {s}^{′} ) - ( 1 - {J}_{{π}_{i}} ( g = {s}^{′} ) ) ln ( 1 - {J}_{{π}_{i}} ( g = {s}^{′} ) ) )}} with η ∈ ℝ , \\ or$$

$$p ( s ) = \frac{\sqrt{{\sum }_{{s}_{N} ∈ {S}_{N ( s )}} {( {J}_{{π}_{i} ( g = {s}_{N} )} - {J}_{{π}_{i} ( g = s )} )}^{2}}}{{\sum }_{{s}^{′} ∈ S} \sqrt{{\sum }_{{s}_{N} ∈ {S}_{N ( {s}^{′} )}} {( {J}_{{π}_{i} ( g = {s}_{N} )} - {J}_{{π}_{i} ( g = {s}^{′} )} )}^{2}}} ,$$

S_{N(S)} representing the set of all adjacent states of s, i.e., all states S_{N}, which are achievable in one step from s by an arbitrary action a.

Target states g may be sampled proportionally to the value of continuous function G applied to gradient ∇_{g}J_{π}_{ᵢ} with

p(s)∝G(∇_{g}J_{π}_{ᵢ}(g=s))

Exemplary continuous functions G in the counter are indicated below, which satisfy this relationship, in particular, as a function of a denominator used for normalizing. The following, for example, are sampled:

$$p ( s ) = \frac{‖ {∇}_{g} {J}_{{π}_{i}} ( g = s ) {‖}_{2}}{{Σ}_{{s}^{′} ∈ S} {‖ {∇}_{g} {J}_{{π}_{i}} ( g = {s}^{′} ) ‖}_{2}} , \\ p ( s ) = \frac{{‖ {∇}_{g} {J}_{{π}_{i}} ( g = s ) ‖}_{2}^{2}}{{{Σ}_{{s}^{′} ∈ S} ‖ {∇}_{g} {J}_{{π}_{i}} ( g = {s}^{′} ) ‖}_{2}^{2}} , \\ p ( s ) = \frac{{e}^{\frac{1}{η} {‖ {∇}_{g} {J}_{{π}_{i}} ( g = s ) ‖}_{2}}}{{Σ}_{{s}^{′} ∈ s} {e}^{\frac{1}{η} {‖ {∇}_{g} {J}_{{π}_{i}} ( g = {s}^{′} ) ‖}_{2}}} , \\ or$$

$$p ( s ) = \frac{{e}^{\frac{1}{η} {‖ {∇}_{g} {J}_{{π}_{i}} ( g = s ) ‖}_{2}^{2}}}{{Σ}_{{s}^{′} ∈ s} {e}^{\frac{1}{η} {‖ {∇}_{g} {J}_{{π}_{i}} ( g = {s}^{′} ) ‖}_{2}^{2}}} .$$

Target states g may be sampled proportionally to the value of continuous function G applied to change ΔᵢJ_{π}_{ᵢ} with

p(s)∝G(ΔᵢJ_{π}_{ᵢ}(g=s))

Exemplary continuous functions G in the counter are indicated below, which satisfy this relationship, in particular, as a function of a denominator used for normalizing. The following, for example, are sampled:

$$p ( s ) = \frac{‖ {Δ}_{i} {J}_{{π}_{i}} ( g = s ) {‖}_{2}}{{Σ}_{{s}^{′} ∈ S} {‖ {Δ}_{i} {J}_{{π}_{i}} ( g = {s}^{′} ) ‖}_{2}} , \\ p ( s ) = \frac{{‖ {Δ}_{i} {J}_{{π}_{i}} ( g = s ) ‖}_{2}^{2}}{{{Σ}_{{s}^{′} ∈ S} ‖ {Δ}_{i} {J}_{{π}_{i}} ( g = {s}^{′} ) ‖}_{2}^{2}} , \\ p ( s ) = \frac{{e}^{\frac{1}{η} {‖ {Δ}_{i} {J}_{{π}_{i}} ( g = s ) ‖}_{2}}}{{Σ}_{{s}^{′} ∈ s} {e}^{\frac{1}{η} {‖ {Δ}_{i} {J}_{{π}_{i}} ( g = {s}^{′} ) ‖}_{2}}} , \\ or$$

$$p ( s ) = \frac{{e}^{\frac{1}{η} {‖ {Δ}_{i} {J}_{{π}_{i}} ( g = s ) ‖}_{2}^{2}}}{{Σ}_{{s}^{′} ∈ s} {e}^{\frac{1}{η} {‖ {Δ}_{i} {J}_{{π}_{i}} ( g = {s}^{′} ) ‖}_{2}^{2}}} ,$$

where ΔᵢJ_{π}_{ᵢ}(g=s), for example, ΔᵢJ_{π}_{ᵢ}(g=s)=J_{π}_{ᵢ}(g=s)−J_{π}_{ᵢ₋ₖ}(g=s) with k∈ [symbol] ₊.

Target states g may be sampled proportionally to the value of continuous function G applied to performance measure J_{π}_{ᵢ} and strategy πᵢ(a|s, g) with

p(s)∝G(J_{π}_{ᵢ}(g=s),πᵢ(a|s))

Exemplary continuous functions G in the counter are indicated below, which satisfy this relationship, in particular, as a function of a denominator used for normalizing. The following, for example, is sampled:

$$p ( s ) = \frac{𝕊 [ {J}_{{π}_{i}} ( g = s ) ]}{{Σ}_{{s}^{′} ∈ S} 𝕊 [ {J}_{{π}_{i}} ( g = {s}^{′} ) ]} ,$$

J_{π}_{ᵢ} in this case being value function Q^{π}^{ᵢ}(s, a, g) (with s=s₀ the fixed given start state) or advantage function A^{π}^{ᵢ}(s, a, g) (with s=s₀ the fixed given start state) and [symbol] [.] the standard deviation with respect to actions a, which are selected either from action space A or in accordance with strategy πᵢ(a|s, g) (with s=s₀ the fixed given start state),

$$p ( s ) = \frac{\sqrt{{\sum }_{a} {( {J}_{{π}_{i}} ( g = s ) )}^{2} {π}_{i} ( a \vert {s}_{0} , g = s )}}{{\sum }_{{s}^{′} ∈ S} \sqrt{{\sum }_{a} {( {J}_{{π}_{i}} ( g = {s}^{′} ) )}^{2} {π}_{i} ( a \vert {s}_{0} , g = {s}^{′} )}} ,$$

J_{π}_{ᵢ} in this case being advantage function A^{π}^{ᵢ}(s, a, g) (with s=s₀ the fixed given start state), or

$$p ( s ) = \frac{{\sum }_{a} \vert {J}_{{π}_{i}} ( g = s ) \vert {π}_{i} ( a \vert {s}_{0} , g = s )}{{\sum }_{{s}^{′} ∈ S} {\sum }_{a} \vert {J}_{{π}_{i}} ( g = {s}^{′} ) \vert {π}_{i} ( a \vert {s}_{0} , g = {s}^{′} )} ,$$

J_{π}_{ᵢ} in this case being advantage function A^{π}^{ᵢ}(s, a, g) (with s=s₀ the fixed given start state).

The criteria explicitly cited here for the case of discrete, finite state spaces S may also be applied by modification to continuous state spaces. The performance measure is estimated in an equivalent manner.

The derivatives may also be calculated for the performance measure, in particular, in the case of a parametric model. For sampling the start states or target states from a continuous state space or from a discrete state space using an infinite number of states, a grid approximation of the state space, for example, takes place or a number of states are pre-sampled in order to determine a finite number of states.

The determination as a function of the derivative, i.e., the gradient-based criterion described therewith, and the criteria, which apply an application of the continuous function to performance measure and strategy, are particularly advantageous with respect to the training progress and thus to the performance.

FIG. 2 represents a first flowchart for parts of a first method for activating technical unit 102. The learning of strategy π(a|s) for a predefined target state g is schematically represented in FIG. 2. More precisely, FIG. 2 represents how a start state selection with meta-strategy π^{s}^{₀}(s₀|J_{π}_{ᵢ}(s₀),∇ₛ_{₀}J_{π}_{ᵢ}(s₀),ΔᵢJ_{π}_{ᵢ}(s₀),πᵢ(a|s)), strategy πᵢ(a|s) and the surroundings with dynamic p(s′|s,a) and reward function r(s,a) interact with each other. The interaction between these is not bound to the order described below. In one implementation, data collecting by interaction of strategy and surroundings, updating of the strategy and updating of the meta-strategy proceed in parallel, for example, as three different processes on different time scales, which exchange pieces of information with one another from time to time.

In a step 200, a strategy πᵢ(a|s) and/or trajectories τ={(s,a,s′,r)} of the episodes of one or multiple preceding training iterations of the strategy are transferred to a start state selection algorithm, which determines start states s₀ for the episodes of one or multiple subsequent training iterations.

It may be provided that a value function, for example, function V(s) or Q(s,a) or an advantage function, i.e., for example, advantage function A(s,a)=Q(s,a)−V(s), is also transferred.

In a step 202, one or multiple start states s₀ are determined. Meta-strategy πᵢ^{s}^{₀}(s₀|J_{π}_{ᵢ}(s₀),∇ₛ_{₀}J_{π}_{ᵢ}(s₀),ΔᵢJ_{π}_{ᵢ}(s₀),πᵢ(a|s)) generates start states s₀ on the basis of performance measure J_{π}_{ᵢ}(s₀=s), of potentially determined derivatives or, in particular, temporal changes thereof and/or of strategy πᵢ(a|s). This takes place individually before each episode or for multiple episodes, for example, for as many episodes as is required for an updating of instantaneous strategy πᵢ(a|s), or for the episodes of multiple strategy updates of strategy πᵢ(a|s).

In a step 204, start states s₀ are transferred from the start state selection algorithm to the algorithm for reinforcement learning.

The algorithm for reinforcement learning collects data in episodic interaction with the surroundings and updates the strategy from time to time on the basis of the at least one portion of the data.

To collect the data, episodes of the interaction of strategy and surroundings, rollouts, are carried out repeatedly. For this purpose, steps 206 through 212 are carried out iteratively in one episode or in one rollout, for example, until a maximum number of interaction steps is achieved, or the target-setting, for example, target state g, is achieved. A new episode starts in a start state s=s₀. A currently up-to-date strategy πᵢ(a|s) selects in step 206 an action a, which is carried out in the surroundings in step 208, whereupon in accordance with dynamic p(s′|s,a) a new state s′ and in accordance with r(s,a), a reward r (may be 0) are determined in step 210, which are transferred to the reinforcement learning algorithm in step 212. The reward is, for example, 1, if s=g and otherwise 0. An episode ends, for example, with the target achievement s=g or after a maximum number of iteration steps T. Thereafter, a new episode starts with a new start state s₀. Tuples (s,a,s′,r), which are generated during an episode, yield a trajectory τ={(s,a,s′,r)}.

Strategy πᵢ(a|s) is updated from time to time in step 206 on the basis of collected data τ={(s,a,s′,r)}. This results in updated strategy πᵢ₊₁(a|s), which selects actions a in subsequent episodes on the basis of state s.

FIG. 3 represents a second flowchart for parts of a second method for activating technical unit 102. The learning of strategy π(a|s,g) for a predefined start state s₀ is schematically represented in FIG. 3. More precisely, FIG. 3 represents how a target state selection with meta-strategy π^{g}(g|J_{π}_{ᵢ}(g),∇_{g}J_{π}_{ᵢ}(g),ΔᵢJ_{π}_{ᵢ}(g),πᵢ(a|s,g)), strategy πᵢ(a|s,g) and the surroundings with dynamic p(s′|s,a) and reward function r(s,a) interact with one another. The interaction between these is not bound to the order described below. In one implementation, data collection by interaction of strategy and surroundings, updating of the strategy and updating of the meta-strategy proceed in parallel, for example, as three different processes on different time scales, which exchange pieces of information with one another from time to time.

In a step 300, a strategy πᵢ(a|s,g) and/or trajectories τ={(s,a,s′,r,g)} of the episodes of one or multiple preceding training iterations of the strategy are transferred to a target state selection algorithm, which determines target states g for the episodes of one or multiple successive training iterations.

It may be provided that a value function, for example, function V(s,g) or Q(s,a,g) or an advantage function, i.e., for example, advantage function A(s,a,g)=Q(s,a,g)−V(s,g) is also transferred.

In a step 302, one or multiple target states g are determined. Meta-strategy πᵢ^{g}(g|J_{π}_{ᵢ}(g),∇_{g}J_{π}_{ᵢ}(g),ΔᵢJ_{π}_{ᵢ}(g),πᵢ(a|s,g)) generates target states g on the basis of performance measure J_{π}_{ᵢ}(g=s), of potentially determined derivatives or, in particular, temporal changes thereof and/or of strategy πᵢ(a|s,g). This takes place individually or before each episode or for multiple episodes, for example, for as many episodes as required for an update of instantaneous strategy π(a|s,g) or for the episodes of multiple strategy updates of strategy π(a|s,g).

In a step 304, target states g are transferred from the target state selection algorithm to the algorithm for reinforcement learning.

The algorithm for reinforcement learning collects data in episodic interaction with the surroundings and updates the strategy from time to time on the basis of the at least one portion of the data.

To collect the data, episodes of the interaction of strategy and surroundings, rollouts, are carried out repeatedly. For this purpose, steps 306 through 312 are carried out iteratively in one episode/in one rollout, for example, until a maximum number of interaction steps is achieved, or the target-setting, for example, target state g is achieved. A new episode starts in a predefined start state s=s₀. A currently up-to-date strategy πᵢ(a|s,g) selects in step 306 an action a, which is carried out in the surroundings in step 308, whereupon in accordance with dynamic p(s′|s,a) a new state s′ and in accordance with r(s,a) a reward r (may be 0) are determined in step 310, which are transferred to the reinforcement learning algorithm in step 312. The reward is, for example, 1, if s=g and otherwise 0. An episode ends, for example, with the target achievement s=g or after a maximum number of iteration steps T. Thereafter, a new episode starts with a new target state g. Tuples (s,a,s′,r,g), which are generated during an episode, yield a trajectory τ={(s,a,s′,r,g)}.

Strategy πᵢ(a|s,g) is updated from time to time in step 306 on the basis of collected data τ={(s,a,s′,r,g)}. This results in updated strategy πᵢ₊₁(a|s,g), which selects actions a in subsequent episodes on the basis of state s and of target g updated at this moment for the episode.

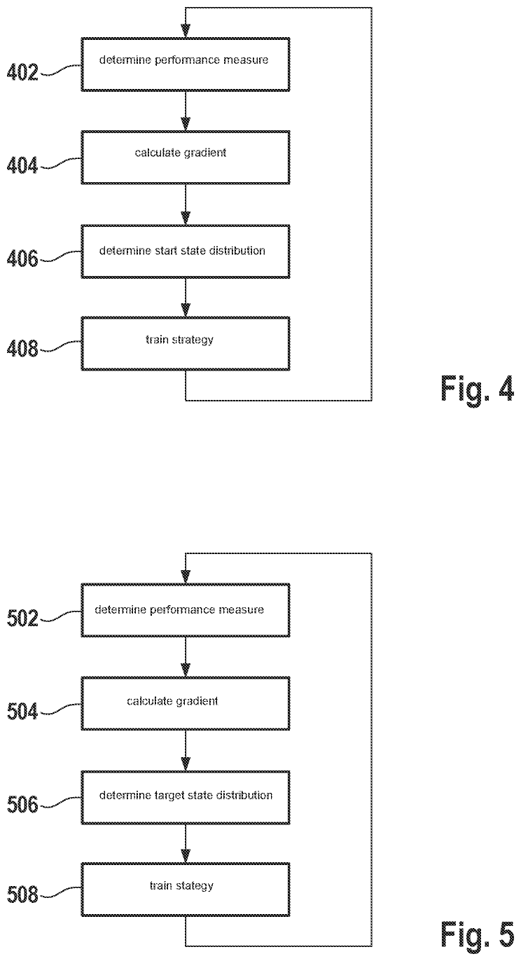

FIG. 4 represents a third flowchart for parts of the first method for activating technical unit 102. FIG. 4 shows a cycle of the start state selection. Multiple start states may be determined for the episodes of one or multiple iterations of strategy πᵢ(a|s).

In a step 402, performance measure J_{π}_{ᵢ}(s₀=s) is determined. In the example, performance measure J_{π}_{ᵢ}(s₀=s) is determined by being estimated:

Ĵ_{π}_{ᵢ}(s₀=s).

This may occur, for example, in that:
interactions with the surroundings are carried out using instantaneous strategy πᵢ(a|s) over multiple episodes and the target achievement probability for each state is calculated therefrom,
the target achievement probability for each state is calculated from rollout data τ of preceding training episodes,
value function V(s), value function Q(s,a) or advantage function A(s,a) is used if this is available,
   and/or
an, in particular, parametric model or an ensemble of parametric models is learned concurrently.

In one optional step 404, the gradient, a derivative or the temporal change of performance measure J_{π}_{ᵢ}(s₀=s) or of estimated performance measure Ĵ_{π}_{ᵢ}(s₀=s) is calculated.

In a step 406, the start state distribution is determined. For this purpose, values of continuous function G are determined in the example by application of function G to performance measure J_{π}_{ᵢ}(S₀=S), to a derivative or to the gradient of performance measure ∇ₛ_{₀}J_{π}_{ᵢ}(s₀=s), to the temporal change of performance measure ΔᵢJ_{π}_{ᵢ}(s₀=s) and/or to strategy πᵢ(a|s)

A state s is determined proportionally to the associated value of continuous function G as start state s₀. Meta-strategy π^{s}^{₀} defined as a function of continuous function G represents a probability distribution across start states s₀ for a predetermined target state g, i.e., with which probability a state s is selected as start state s₀.

In a continuous state space or in a discrete state space including an infinite number of states, the probability distribution is potentially determined only for a finite set of previously determined states. A rough grid approximation of the state space may be used for this purpose.

In the example, start states s₀ are determined with one of the following possibilities using the probability distribution defined as a function of continuous function G:
start states s₀ are determined, i.e., directly sampled, in particular in the case of discrete, finite state spaces S, according to the probability distribution across start states s₀,
start states s₀ are determined with the aid of rejection sampling of the probability distribution,
start states s₀ are determined with the aid of a Markov Chain Monte Carlo sampling of the probability distribution,
start states s₀ are determined by a generator, which is trained to generate start states according to the start state distribution.

In one aspect, it is possible in addition to or instead of these start states to determine with an additional heuristic additional start states close to these start states. The heuristic may, for example, encompass random actions or Brownian motion. The performance or robustness is enhanced by this aspect.

In a step 408, strategy π(a|s) is trained using a reinforcement learning algorithm for one or multiple training iterations in interaction with the surroundings.

In the example, strategy π(a|s) is trained by an interaction with technical unit 102 and/or its surroundings in a plurality of training iterations.

In one aspect, start states s₀ for the episodes or rollouts of strategy π(a|s) in the surroundings for training strategy π(a|s) are determined as a function of the start state distribution for this training iteration.

Start states s₀ for different iterations are determined in accordance with the start state distribution determined for the respective iteration or iterations in step 406.

Interaction with technical unit 102 in this example means an activation of technical unit 102 with an action a.

Step 402 is carried out after step 408.

Steps 402 through 408 in the example are repeated until strategy π(a|s) achieves a quality measure, or until a maximal number of iterations has taken place.

In one aspect, technical unit 102 is subsequently further activated using strategy π(a|s) determined in the last iteration.

FIG. 5 represents a fourth flowchart for parts of the second method for activating technical unit 102. FIG. 5 shows a cycle of the target state selection. Multiple target states may be determined for the episodes of one or multiple iterations of strategy πᵢ(a|s,g).

In a step 502, performance measure J_{π}_{ᵢ}(g=s) is determined. In the example, performance measure J_{π}_{ᵢ}(g=s) is estimated: Ĵ_{π}_{ᵢ}(g=s).

This may occur in that:
interactions with the surroundings are carried out using instantaneous strategy πᵢ(a|s,g) across multiple episodes and the target achievement probability is calculated therefrom for each state,
the target achievement probability for each state is calculated from rollout data τ of preceding training episodes,
value function V(s,g), value function Q(s,a,g) or advantage function A(s,a,g) of the algorithm for reinforcement learning is used, if this is available,
   and/or
an, in particular, parametric model or an ensemble of parametric models is learned concurrently.

In an optional step 504, the gradient, a derivative or the temporal change of performance measure J_{π}_{ᵢ}(g=s) or of estimated performance measure Ĵ_{π}_{ᵢ}(g=s) is calculated.

In a step 506, the target state distribution is determined. For this purpose, values of continuous function G are determined in the example by application of function G to performance measure J_{π}_{ᵢ}(g=s), to a derivative or to the gradient of performance measure ∇_{g}J_{π}_{ᵢ}(g=s), to the temporal change of performance measure ΔᵢJ_{π}_{ᵢ}(g=s) and/or to strategy πᵢ(a|s,g).

A state s is determined proportionally to the associated value of continuous function G as target state g. Meta-strategy π^{g} defined as a function of continuous function G represents a probability distribution across target states g for a predefined start state s₀, i.e., with which probability a state s is selected as target state g.

In a continuous state space or in a discrete state space including an infinite number of states, the probability distribution is potentially determined only for a finite set of previously determined states. A rough grid approximation of the state space may be used for this purpose.

In the example, target states g are determined with one of the following possibilities using the probability distribution defined as a function of continuous function G:
target states g are determined, i.e., directly sampled, in particular for a discrete, finite state space S, according to the probability distribution across target states g,
target states g are determined with the aid of rejection sampling of the probability distribution,
target states g are determined with the aid of a Markov Chain Monte Carlo sampling of the probability distribution,
target states g are determined by a generator, which is trained to generate target states according to the target state distribution.

In one aspect, it is possible in addition to or instead of these target states to determine with an additional heuristic additional target states close to these target states. The heuristic may, for example, encompass random actions or Brownian motion. The performance or robustness is enhanced by this aspect.

In a step 508, strategy πᵢ(a|s,g) is trained using a reinforcement learning algorithm for one or multiple training iterations in interaction with the surroundings.

In the example, strategy πᵢ(a|s,g) is trained by an interaction with technical unit 102 and/or its surroundings in a plurality of training iterations.

In one aspect, target states g for the episodes or rollouts of strategy πᵢ(a|s,g) in the surroundings for training strategy πᵢ(a|s,g) are determined as a function of the target state distribution for these training iterations.

Target states g for different iterations are determined in accordance with the target state distribution determined for the respective iteration or iterations in step 506.

Interaction with technical unit 102 in this example means an activation of technical unit 102 with an action a.

Steps 502 through 508 in the example are repeated until strategy π(a|s,g) achieves a quality measure, or until a maximal number of iterations has taken place.

In one aspect, technical unit 102 is subsequently further activated using strategy π(a|s,g) determined in the last iteration.

In one aspect, the start state and/or target state selection algorithm obtain(s) the instantaneous strategy from the reinforcement learning algorithm, data collected during the interaction episodes of preceding training iterations, and/or a value or advantage function. The start state and/or target state selection algorithm initially estimates the performance measure on the basis of these components. If necessary, the derivative or, in particular, the temporal change of this performance measure is determined. The start state and/or target state distribution, the meta-strategy, is then determined on the basis of the estimated performance measure by applying the continuous function. If necessary, the derivative or, in particular, the temporal change of this performance measure and/or the strategy is also used. Finally, the start state and/or the target state selection algorithm provide(s) the determined start and/or the determined target state distribution, the meta-strategy, to the reinforcement learning algorithm for one or multiple training iterations. The reinforcement learning algorithm then trains the strategy for the corresponding number of training iterations, the start states and/or target states of the one or multiple interaction episodes being determined within the training iterations corresponding to the meta-strategy of the start state and/or target state selection algorithm. The sequence subsequently begins anew until the strategy achieves a quality measure or a maximal number of training iterations has been carried out.

The strategies described are implemented, for example, as artificial neural networks, whose parameters are updated in iterations. The meta-strategies described are probability distributions, which are calculated from the data. In one aspect, these meta-strategies access neural networks, whose parameters are updated in iterations.

1-12. (canceled)

13. A computer-implemented method for activating a technical unit, the technical unit being a robot, or an at least semi-autonomous vehicle, or a house control system, or a household appliance, or a DIY tool, or a power tool, or a manufacturing machine, or a personal assistance device, or a monitoring system, or an access control system, the method comprising the following steps:
determining a state of at least one part of the technical unit or of surroundings of the technical unit as a function of input data;
determining at least one action being determined as a function of the state and of a strategy for the technical unit; and
activating the technical unit to carry out the at least one action;
wherein the strategy is represented by an artificial neural network and is learned with a reinforcement learning algorithm in interaction with the technical unit or with the surroundings of the technical unit, as a function of the at least one feedback signal, the at least one feedback signal being determined as a function of a target-setting, at least one start state and/or at least one target state for an interaction episode being determined proportionally to a value of a continuous function, the value being determined: (i) by applying the continuous function to a performance measure previously determined for the strategy, and/or (ii) by applying the continuous function to a derivative of a performance measure previously determined for the strategy, and/or or (iii) by applying the continuous function to a temporal change of a performance measure previously determined for the strategy, and/or (iv) by applying the continuous function to the strategy.

14. The computer-implemented method as recited in claim 13, wherein the performance measure is estimated.

15. The computer-implemented method as recited in claim 14, wherein the estimated performance measure is defined by a state-dependent target achievement probability, which is determined for possible states or for a subset of possible states, at least one action and at least one state to be expected or resulting from an execution of the at least one action by the technical unit being determined using the strategy starting from the start state, the target achievement probability being determined as a function of the target-setting, and as a function of at least one to be expected or resulting state.

16. The computer-implemented method as recited in claim 15, wherein the target-setting is of a start state.

17. The computer-implemented method as recited in claim 14, wherein the estimated performance measure is defined by a value function or advantage function, which is determined as a function of at least one state and/or at least one action and/or of the start state and/or of the target state.

18. The computer-implemented method as recited in claim 14, wherein the estimated performance measure is defined by a parametric model, the model being learned as a function of at least one state and/or at least one action and/or of the start state and/or of the target state.

19. The computer-implemented method as recited in claim 13, wherein the strategy is trained by interaction with the technical unit and/or the surroundings, at least one start state being determined as a function of a start state distribution and/or at least one target state being determined as a function of a target state distribution.

20. The computer-implemented method as recited in claim 13, wherein a state distribution is defined as a function of the continuous function, the state distribution defining either a probability distribution for a predefined target state across start states, or defining a probability distribution for a predefined start state across target states.

21. The computer-implemented method as recited in claim 20, wherein a state is defined for a predefined target state as the start state of an episode or for a predefined start state as the target state of an episode, the defined state being determined by a sampling method.

22. The computer-implemented method as recited in claim 21, wherein the defined state is determined as a function of a state distribution in a discrete, finite state space.

23. The computer-implemented method as recited in claim 21, wherein the defined state is determined as a function of a finite set of possible states of a continuous or infinite state space using a rough grid approximation of the state space.

24. The computer-implemented method as recited in claim 13, wherein the input data are defined by data from a sensor, the sensor being a video sensor or a radar sensor or a LIDAR sensor or an ultrasonic sensor or a motion sensor or a temperature sensor or a vibration sensor.

25. A non-transitory computer readable memory on which is stored a computer program for activating a technical unit, the technical unit being a robot, or an at least semi-autonomous vehicle, or a house control system, or a household appliance, or a DIY tool, or a power tool, or a manufacturing machine, or a personal assistance device, or a monitoring system, or an access control system, the computer program, when executed by a computer, causing the computer to perform the following steps:
determining a state of at least one part of the technical unit or of surroundings of the technical unit as a function of input data;
determining at least one action being determined as a function of the state and of a strategy for the technical unit; and
activating the technical unit to carry out the at least one action;
wherein the strategy is represented by an artificial neural network and is learned with a reinforcement learning algorithm in interaction with the technical unit or with the surroundings of the technical unit, as a function of the at least one feedback signal, the at least one feedback signal being determined as a function of a target-setting, at least one start state and/or at least one target state for an interaction episode being determined proportionally to a value of a continuous function, the value being determined: (i) by applying the continuous function to a performance measure previously determined for the strategy, and/or (ii) by applying the continuous function to a derivative of a performance measure previously determined for the strategy, and/or or (iii) by applying the continuous function to a temporal change of a performance measure previously determined for the strategy, and/or (iv) by applying the continuous function to the strategy.

26. A device for activating a technical unit, the technical unit being a robot, or an at least semi-autonomous vehicle, or a house control system, or a household appliance, or a DIY tool, or a power tool, or a manufacturing machine, or a personal assistance device, or a monitoring system, or an access control system, the device comprising:
an input for input data from at least one sensor, the sensor including a video sensor, or a radar sensor, or a LIDAR sensor, or an ultrasonic sensor, or a motion sensor, or a temperature sensor, or a vibration sensor;
an output for activating the technical unit using an activation signal;
a computing device configured to activate the technical unit as a function of the input data, the computer device configured to:
determine a state of at least one part of the technical unit or of surroundings of the technical unit as a function of the input data;
determine at least one action being determined as a function of the state and of a strategy for the technical unit; and
activate the technical unit to carry out the at least one action;
wherein the strategy is represented by an artificial neural network and is learned with a reinforcement learning algorithm in interaction with the technical unit or with the surroundings of the technical unit, as a function of the at least one feedback signal, the at least one feedback signal being determined as a function of a target-setting, at least one start state and/or at least one target state for an interaction episode being determined proportionally to a value of a continuous function, the value being determined: (i) by applying the continuous function to a performance measure previously determined for the strategy, and/or (ii) by applying the continuous function to a derivative of a performance measure previously determined for the strategy, and/or or (iii) by applying the continuous function to a temporal change of a performance measure previously determined for the strategy, and/or (iv) by applying the continuous function to the strategy.
